(19) United States
(12) Patent Application Publication
(10) Pub. No.: US 2009/0030561 A1
(43) Pub. Date: Jan. 29, 2009

(54) VEHICLE HANDLING BIAS CONTROL SYSTEM

(76) Inventors: Dimitry O. Gurieff, New South Wales (AU); Robert J. Tait, New South Wales (AU)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/909,201

(22) PCT Filed: Mar. 20, 2006
(86) PCT No.: PCT/AU2006/000367

§ 371 Date: May 27, 2008

(30) Foreign Application Priority Data
Mar. 21, 2005 (AU) 2005901381

(51) Int. Cl. G06F 17/00

(52) U.S. Cl. 701/1

(57) ABSTRACT

A system for modifying the handling bias of a vehicle having one or more dynamic parameter sensors (114, 115) which produce sensor signals representative of parameters indicative of the current handling performance of a vehicle, and a vehicle handling performance controller (106) responsive to the or each sensor signal to produce parameter control signals which are applied to parameter control devices to adjust the parameter towards a desired value in relation to the vehicles current handling status, the handling bias modifying system including a signal modifier (506) which receives and modifies one or more of the sensor signals and/or one or more of the parameter control signals.

### FIELD OF THE INVENTION

The present invention relates to a method and system for adjusting the handling characteristics of a vehicle. The invention is particularly suited to dynamic adjustment of the handling characteristics of a vehicle while the vehicle is in motion.

### DESCRIPTION OF THE ART

Electronic Stability Control (ESC) systems are provided on some vehicles. ESC systems use sensors to detect various parameters relating to the dynamic status of a vehicle and use these to adjust one or more controls when the parameters reach certain predetermined values to keep the handling performance of the vehicle within predetermined limits which are known as a chassis control map. Parameters which are detected may include, for example, wheel speed for each wheel, yaw rate, steering angle, slip angle, braking force, etc.

Some vehicles permit a driver to select pre-programmed chassis control maps depending on the road conditions, e.g., bitumen, sand, mud. However, the actual performance which these options provide is pre-programmed and not within the control of the driver.

### SUMMARY OF THE INVENTION

This invention proposes a system arrangement and method whereby the driver can control one or more handling parameters.

The invention provides a method of adjusting the handling characteristics of a vehicle, the method including:

monitor one or more dynamic parameters which influence handling of the vehicle to produce one or more parametric signals representing the monitored parameters;
modifying at least one of the parametric signals in response to a command from a control signal generator,
and using one or more of the modified parametric signals to control one or more vehicle control devices.

The invention also provides a system for adjusting the handling characteristics of a vehicle having one or more sensors to monitor one or more parameters which influence vehicle performance and produce corresponding parametric signals, the vehicle including one or more control devices to control the handling characteristics of the vehicle, the system including: a control signal generator; a signal modifier responsive to the control signal generator to modify at least one of the parametric signals;

signal processing means to process at least one of the modified parametric signals to produce one or more control signals to control at least one of the control devices.

One embodiment of the invention provides a system for controlling vehicle handling characteristics by the use of a driver interface which minimizes the number of operator inputs.

In a further embodiment, the handling characteristics can be controlled from within the cabin of the vehicle.

the term “driver” is used in this specification to indicate a person having control of the vehicle, but the term can also include a further person who controls the vehicle handling parameters, such as a rally car navigator.

According to an embodiment of the invention, this specification discloses a system for modifying the handling bias of a vehicle having one or more dynamic parameter sensors which produce sensor signals representative of parameters indicative of the current handling performance of a vehicle, and a vehicle handling performance controller responsive to the or each sensor signal to produce parameter control signals which are applied to parameter control devices to adjust the parameter towards a desired value in relation to the vehicles current handling status, the handling bias modifying system including a sensor signal modifier which receives and modifies one or more of the sensor signals and/or one or more of the parameter control signals.

The system can include an in-cockpit modifier controller having one or more control interfaces to permit a driver to adjust the modification of the sensor signals.

The modifier controller can include a first interface which is adapted to enable the driver to select the nature of the modification of one or more of the signals.

The modifier controller can include a second interface which is adapted to enable the driver to select the magnitude profile of the modification of one or more of the signals. The term “magnitude profile” refers to the variation of the magnitude of the modification with the current vehicle status, such as is contained in the chassis control map.

A further embodiment of the invention provides a method of retrofitting a handling bias modifier to a vehicle equipped with one or more dynamic parameter sensors which produce sensor signals representative of parameters indicative of the current handling performance of a vehicle, and a vehicle handling performance controller responsive to the or each sensor signal to produce parameter control signals which are applied to parameter control devices to adjust the parameter towards a desired value in relation to the vehicles current handling status, the method including inserting a handling bias modifier between at least one of the sensors and the ESC, and modifying one or more of the sensor signals before applying the modified sensor signal to the vehicle handling performance controller.

The method can include providing one or more driver-actuated interface controls to enable the driver to control the nature and/or degree of modification of the sensor signal.

An embodiment of the invention also provides an in-cabin handling bias modifier.

### BRIEF DESCRIPTION OF THE DRAWINGS

Further preferred embodiments of the invention will now be described with reference to the accompanying drawings, in which:

FIG. 1 is a schematic illustration of a vehicle fitted with an ESC system;

FIG. 2 is a representation of an in-cabin handling bias modifier according to an embodiment of the invention;

FIG. 3 is a block diagram showing a handling bias modifier retrofitted to an existing ESC system;

FIG. 4 is a block diagram showing detail of the arrangement of FIG. 3;

FIG. 5 shows a first embodiment of the invention applied to the yaw rate signal;

FIG. 6 is a block diagram of a second embodiment of the invention applied to the yaw rate signal and the lateral acceleration signal;

FIG. 7 is a block diagram showing an embodiment of the invention applied to the yaw rate signal, the lateral acceleration signal and the steering angle signal;

FIG. 8 is a chart illustrative of the principle of modification of a monitored yaw signal to produce a modified control signal to increase oversteer.

FIG. 9 is a modified version of the chart of FIG. 8;

FIG. 10 is a second variation of the chart of FIG. 8;

FIG. 11 is a chart illustrating an increase in the apparent measured value to increase understeer;

FIG. 12 is a chart representing a non-linear control signal/yaw signal modified to increase understeer.

### DETAILED DESCRIPTION OF THE PREFERRED EMBODIMENTS

One of the main characteristics which influences a drivers “feel” for the handling of a vehicle is its propensity to understeer or oversteer and skilled drivers may have a preference for one or the other of these types of handling in different conditions. An understeering car will feel “tight” and tend to “push ahead” when turning where as an oversteering car will feel “loose” and feel like the rear wheels are pivoting on the front. There are currently mechanical devices available that alter swaybar (anti-sway) or roll bar settings, devices that alter effective spring rates and even shock absorber rates. Equally there are existing commercial methods to alter the vehicles dynamic characteristics through permanent or durable changes to the computerised “map” of vehicle dynamics held on the chassis computer. However, such systems require reprogramming or alteration of the system and provide a “one off” change. They do not provide a means for the driver to adjust the handling performance to a state selected by the driver, nor do they provide the driver to change the settings at will. This invention provides an adjustment control which permits a driver to select a preferred handling performance bias.

An embodiment of the invention will be described in the context of a vehicle fitted with an Electronic Stability Control (ESC) system. ESC systems typically use wheel speed, steering angle, accelerator, brake pressure, lateral acceleration and yaw rate sensors as well as an interface to the engine management computer to monitor the dynamic state of the car and the driver intent. By comparing the current state of the vehicle to a simplified theoretical model, the ESC system can tell if the actual vehicle behaviour is following the drivers intended behaviour. If the vehicle is in a critical state such as under or oversteer, or experiencing high vehicle slip angles, the ESC system will actively attempt to correct the vehicle's behaviour. The ESC system attempts to primarily control the chassis yaw rate D and vehicle slip β. It does this via controlling the available outputs, which are typically braking and engine power. To control yaw, actual yaw rate of the car which can be measured directly or estimated, is compared to the desired yaw rate based on the steering angle, velocity of the car and as well as internal parameters such as the understeer coefficient of the chassis and tyre grip, actual slip angle of the car is estimated using a function of the available sensors and internal model parameters. It is compared to the internal function of slip angle to ensure that the outputs are stable and within the predefined chassis limits. Additional sensor parameters such as steering angle velocity can also be used to allow for greater functionality in determining driver intent, such as determining a panic input. For a standard unmodified ESC system to achieve good levels of performance, currently there is need for wheel speed, steering angle, brake pressure, lateral acceleration and yaw rate sensors. Communication with the engine management computer is also required to intelligently regulate engine torque.

Typical examples of calculations performed by the ESC may take the form set out below by way of example only:

βₑ=f₁(δ,a_{y},Ωₑ,v_{fl},v_{fr},vᵣₗ,vᵣᵣ,B_{f}, . . . )

β_{d}=f₂(δ,a_{y},Ωₑ,v_{fl},v_{fr},vᵣₗ,vᵣᵣ,B_{f}, . . . )

Ωₑ=Ω or f₃(δ,a_{y},v_{fl},v_{fr},vᵣₗ,vᵣᵣ, . . . )

Ω_{d}=f₄(δ,v_{fl},v_{fr},vᵣₗ,vᵣᵣ,B_{f}, . . . )

where:
Ωₑ=Estimated slip angle
β_{d}=Desired slip angle
Ω=Measured yaw rate
Ωₑ=Estimated yaw rate.
Ω_{d}=Desired yaw rate
a_{y}=Lateral acceleration
v_{fl}=Front left wheel velocity
v_{fr}=Front right wheel velocity
vᵣₗ=Rear left wheel velocity
vᵣᵣ=Rear right wheel velocity
δ=Steering angle

The slip angle is the angle between the direction the wheel is pointing and the direction it is travelling.

Lateral acceleration may be measured by, for example, a micromechanical Coriolis effect sensor.

In an understeer situation the ESC system will, for example, apply a corrective moment (radial force) by appropriately braking the inside rear wheel. In an oversteer situation, the outside front wheel is braked. These are only typical responses and the wheels to be braked can be any combination that generates the desired corrective moment on the chassis. Engine power may be reduced in both cases if appropriate to allow greater effect. The ESC system may limit the desired yaw rate to control vehicle slip angle to ensure it is within acceptable limits. The ESC system also provides traction and ABS functionality, and can be programmed for other driver assistance features. There are a number of known additional variations to this system and it is probable that there will be changes in the future however the outcome or aim is constant.

In one embodiment, an in-cockpit handling bias modifier utilises the existing ESC system to allow the user to adjust the behaviour of the vehicle. This can be done in a number of different ways. The inputs to the ESC system are intercepted and modified so that the ESC system will generate the desired moment on the chassis to produce the handling bias the driver desires. In further embodiments, the invention provides for the modification of other electronically assisted features of the vehicle such as electronic power steering assistance.

A bias modifier according to an embodiment of the invention is placed between the sensors and the existing ESC controller. To allow for basic modification of the existing ESC system, the yaw sensor requires modification and emulation.

In one embodiment, a bias modifier can make an ESC system with neutral to understeer behaviour move the chassis into oversteer by intercepting the incoming signals and modify them to make the chassis appear to have more apparent understeer. This can be achieved by making the yaw rate appear lower than it actually is. The basic handling bias modifier modifies the yaw rate signal.

The intermediate and higher order modifiers can modify additional signals such as lateral acceleration and/or steering angle and/or velocity based on the simplified chassis model to produce a more customisable outcome. This can be done by calculating the theoretical ideal behaviour of the car, and then adding the desired user selected handling bias. The ESC system will then apply a corrective action to the virtual understeer to generate an actual oversteer condition.

In a similar fashion the chassis can be made to understeer by modifying the input ESC signals so that it appears the chassis is oversteering.

Apart from moving the chassis into different handling biases, modifying the ESC inputs allows for custom handling profiles to be implemented. If the handling bias modifier is set to modify the signals so that the ESC system is always in its desired envelope, the chassis assumes its natural mechanical handling properties without ESC intervention.

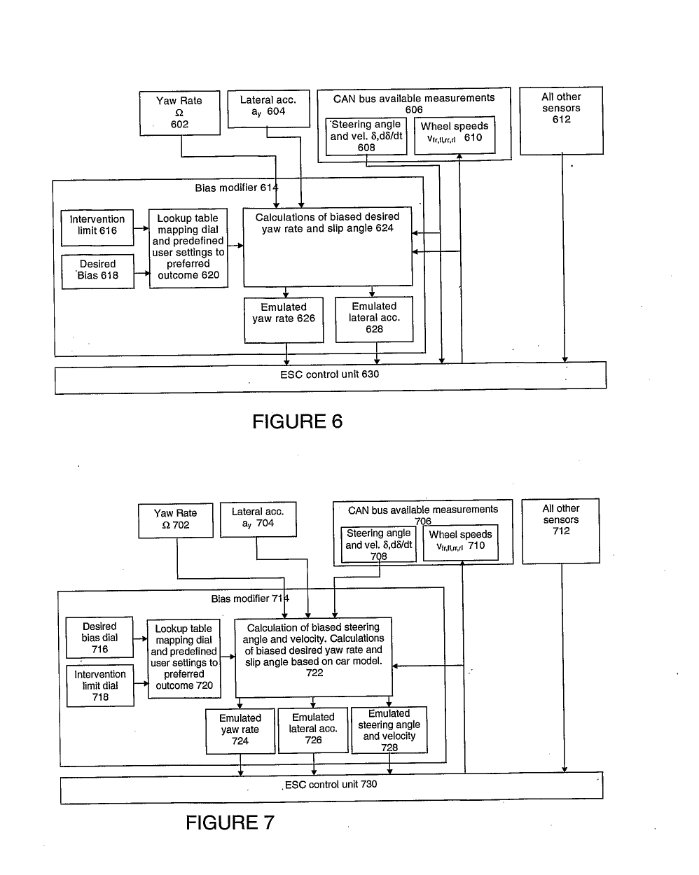

Intermediate control over the ESC system requires modification and emulation of the yaw and lateral sensor and monitoring of wheel speed and steering angle (FIG. 6).

For high amounts of control of the ESC system, emulation of the steering angle and steering velocity sensor is also required (FIG. 7). Lookup tables are used by the bias modifier system to allow the driver to predefine or tune the system to their liking and set non-linear dial behaviour. An example of the lookup table functionality is to change the stability behaviour of the car at different velocities or steering angles. The lookup table is a multidimensional array that maps bias and intervention magnitude to the dial settings and vehicle speed, steering angles and ECU conditions. The intermediate and high control ESC system bias modifiers also contain a mathematical model of the vehicle. This model is based on a simplified bicycle interpretation of vehicle dynamics to allow the system to determine the optimum values of yaw rate and lateral acceleration for a given user input. This vehicle model can be made more accurate if more processing resources are available. The user is able to software modify the table as well as car model parameters to their liking via a communications port on the bias modifier. For the basic modification of the yaw signal, the sensor output is scaled in an appropriate way and can be error checked using the built in test functions of the sensor. For all other methods of modification, the system uses the model of the car to determine the ideal yaw rate and slip angle, it then adds the user-determined bias to generate the yaw rate, lateral acceleration and optionally steering angle and rate signals to transmit to the ESC system. The same chassis bias modifier hardware is able to do all three strategies depending on the loaded software program.

In one embodiment, this invention proposes a system and method to permit the driver to select the degree of understeer/oversteer of a vehicle.

Preferably, this is done using a limited number of input controls.

The input controls allow the driver to preferentially select handling performance along the understeer/oversteer spectrum.

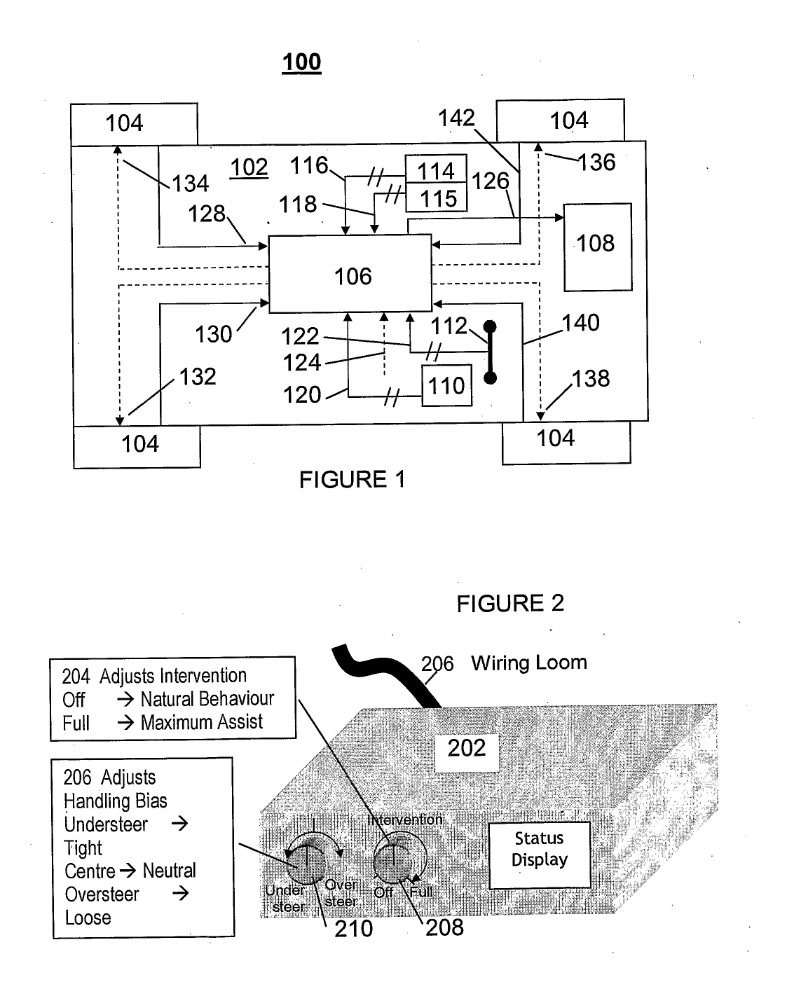

Referring to FIG. 1, a vehicle 100 having a chassis 102 and four wheels 104 is fitted with an ESC system 106. The vehicle includes an engine management system 108, brakes 110, steering wheel 12, lateral sensor 114 and yaw sensor 115.

The wheels are connected to ESC system 106 via signal lines 128, 130, 140, 142 to report the wheel status to the ESC 106. Hydraulic lines 132, 134, 136, 138 control the individual wheel brakes.

Brake pedal information is fed to ESC 106 via line 120.

Steering wheel position information is fed to ESC via line 122.

ESC 106 transmits signals to the engine management system 108 via line 126.

Lateral acceleration information is fed from lateral acceleration sensor 114 to ESC 106 via line 116.

Yaw rate information is fed from yaw sensor 115 to ESC 106 via line 118.

While the signal lines are shown as a star configuration focussing on the ESC 106, some or all of the signals may be carried on a common bus.

FIG. 2 illustrates a box suitable for containing a handling modifier control according to an embodiment of the invention. The box 202 has a pair of knobs 208, 210 for controlling the modification of ESC input signals. The knob 202 controls the type of modification and the knob 210 controls the size of the modification. A cable harness 206 links the handling modifier controller 202 to the sensors generating the ESC input signals and to the ESC circuit. The control box 202 can be mounted within reach of the driver so adjustment can be made at any time while the driver is in the vehicle.

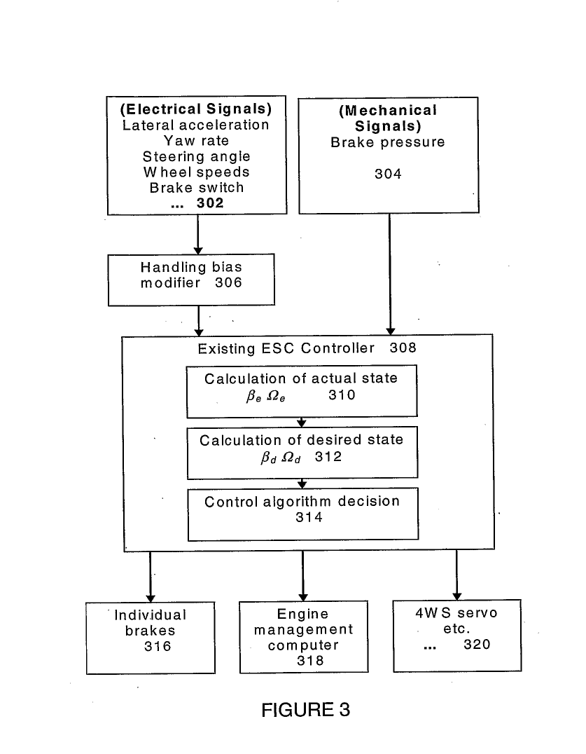

FIG. 3 is a block diagram showing the handling modifier 306 inserted between the sensors shown generally at 302 and the ESC system 308. In this position, the handling modifier 306 is able to modify one or more of the input signals to the ESC and to monitor other ESC input signals. At 310, the ESC may, for example, calculate the estimated slip angle βₑ and the estimated yaw rate Ωₑ from the in put signals and may also calculate the desired values for these parameters at 312, and then, at 314, calculate correction signals to control vehicle functions to return the vehicle to the desired state as determined from a chassis control map using a pre-programmed algorithm. The ESC then controls the individual brakes 316, the engine management system 318, and the four wheel steering system 320 (if fitted). Thus the handling modifier 306 can influence the handling performance by modifying one or more of the input signals to the ESC 308.

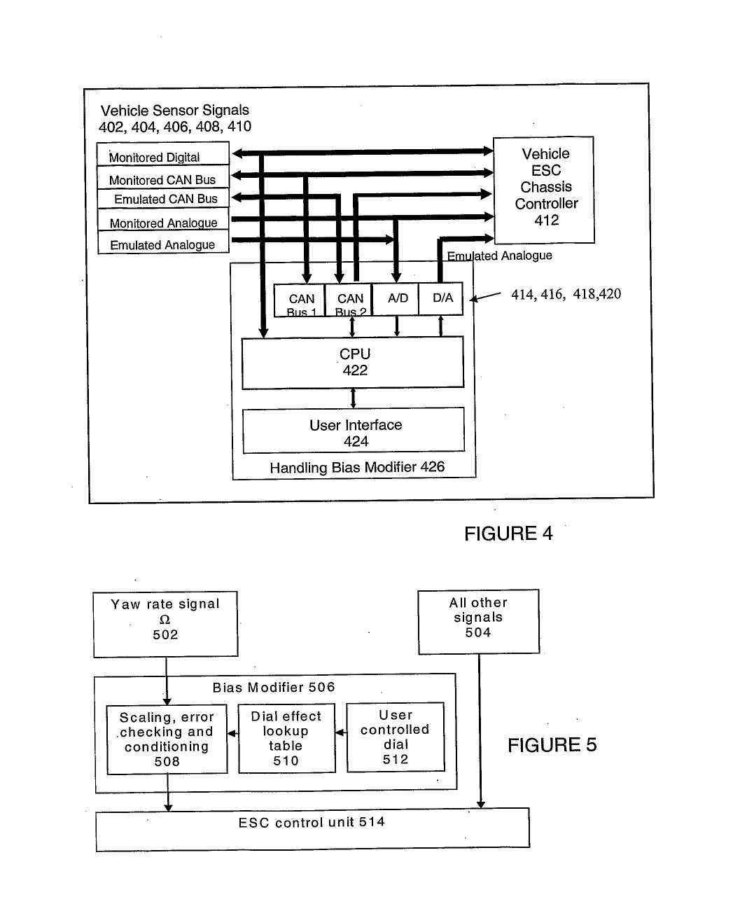

FIG. 4 shows details of the connections of the handling bias modifier 426, the sensors 402, 404, 406, 408, 410, and the ESC 412. The handling bias modifier 426 is shown schematically as including interface 414 which feeds CAN bus signals to the processor 422 for monitoring, interface 416 for feeding CAN bus signals to the processor for modification and relaying the modified signals to the ESC 412, analog/digital converter 418 for converting analog signals to the processor 422, and digital to analog converter 420 for converting digital signals from the processor to analog inputs for the ESC 412. These signals can also be modified in the processor. In addition, digital signals from other sensors in a suitable form can be fed directly to the processor 422.

A CAN(Controller Area Network) bus is a signal bus which uses a protocol defined in ISO 11898.

The user interface 424, which can correspond to the knobs 208, 210 of FIG. 2, enables the driver to select the handling bias. This enables the driver to select the type and degree of bias the vehicle exhibits.

FIG. 5 shows an arrangement including an embodiment of the invention in which the handling bias modifier 506 adapted to operate on the yaw signal 502 only. The user controlled dial 512 enables the driver to set the levels of modification by the use of the lookup table 510. This provides modification factors which are used to modify the yaw signal 502. The modified yaw signal is then substituted as the yaw signal input for the ESC 514.

FIG. 6 shows a further embodiment of a system using the inventive concept in which both yaw and lateral acceleration signals are modified by the handling bias modifier 614.

The driver can select modification factors such as the point at which intervention commences at 616, and the level of intervention at 618 via the lookup table 620. The lookup table provides modification factors or coefficients to the processor 624 which also receives the yaw rate signal 602 and the lateral acceleration signal 604, which are to be modified, as well as the other CAN bus signals 606 such as steering angle 608 and wheel speeds 610.

The additional CAN bus signals 608, 610 can be used to adjust the degree of modification which the processor will apply to the taw rate 602 and the lateral acceleration 604 depending on the overall state of the vehicle as determined by the additional CAN bus signals.

The emulated yaw rate 626 and the emulated lateral acceleration 628 are applied to the corresponding inputs of the ESC 630.

FIG. 7 shows a further embodiment in which a further degree of sophistication is added by including the steering angle 708 as one of the signals to be modified.

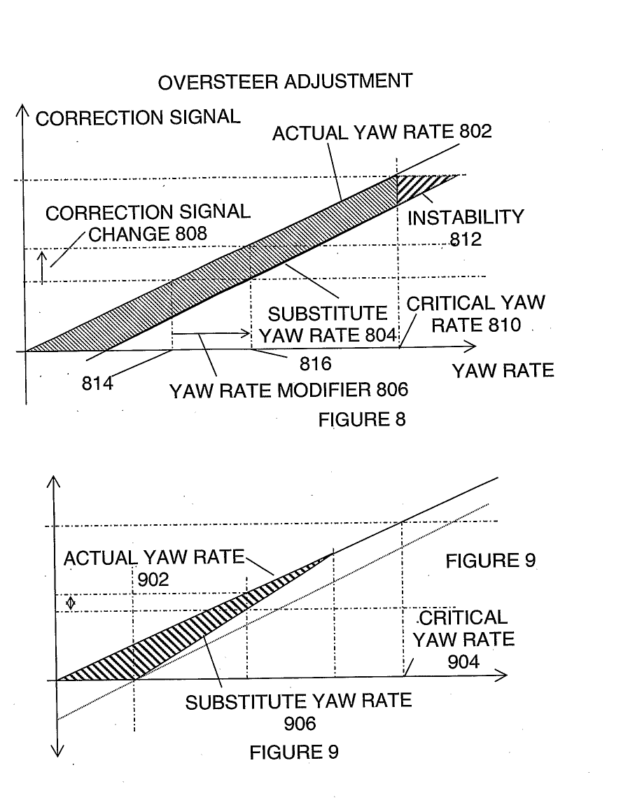

Referring to FIG. 8, the chart shows yaw rate along the abscissa and the resulting correction signal as the ordinate. In an ESC system, the correction signal is normally calculated from the yaw rate signal 802. The relationship between the actual or estimated yaw rate 802 and the correction signal is shown as linear in this chart. However, in practice, the relationship between the yaw rate signal and the control signal may be non-linear. In this embodiment of the invention, the actual yaw rate signal 802 is modified by the addition of a constant yaw rate modifier signal 806 in a linear manner to produce a parallel substitute yaw rate signal 804. This modified substitute yaw rate signal 804 is substituted for the actual yaw rate signal 802 in the ESC system to calculate the modified correction signal.

Thus, if the actual yaw rate is 814, the addition of the modifier 806 gives an apparent yaw rate of 816. A correction signal of 818 corresponds to the actual yaw rate signal 814, but the substitute yaw rate signal 814 will produce a correction signal of 820 because the ESC system now sees the substitute yaw rate signal 804. As shown on the chart, the new correction signal differs from the expected correction signal by the correction signal change 808. As the system is set up to produce increased oversteer, this means that additional braking force will be applied, for example, to the inside rear wheel. By making the ESC system react to a greater yaw rate signal than the actual yaw rate signal, the ESC system will produce a greater correction signal than it would produce for the actual yaw rate.

In some ESC systems, there may be a critical yaw rate 810 below which the actual yaw rate needs to kept to avoid instability region 812 beyond the critical value. Because a sudden change from the substitute yaw rate to the actual yaw rate at the critical yaw rate may trigger the instability, the substitute yaw rate signal can be merged with the actual yaw rate signal before the critical yaw rate is reached, as shown in FIG. 9.

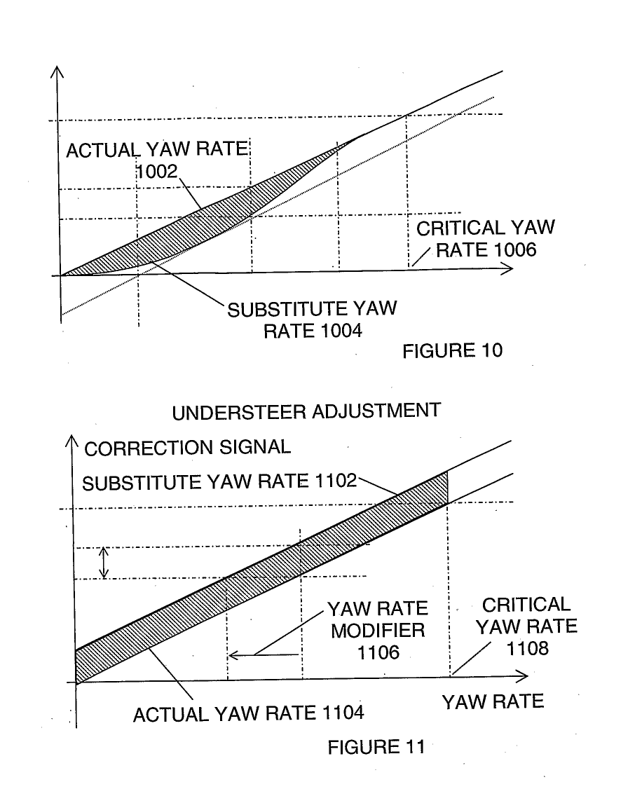

FIG. 10 shows a further modification of the chart of FIG. 9 in which the modifier is non-linear.

FIG. 11 is a chart showing an embodiment in which the yaw rate signal is modified to produce an enhanced understeer bias. In this arrangement, the substitute yaw rate signal 1102 is generated by deducting the yaw rate modifier 1106 from the actual yaw rate. Because the substitute yaw rate signal 1102 is less than the actual yaw rate signal 1104, the ESC will produce a smaller correction signal than the ESC system would otherwise produce for the actual yaw rate.

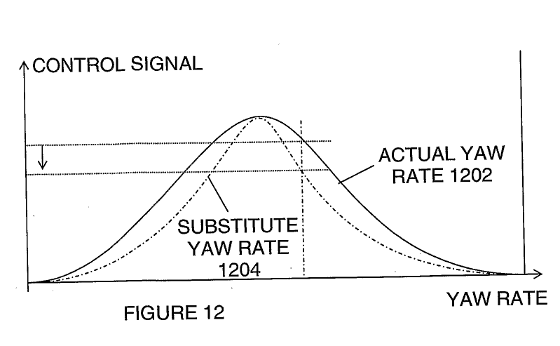

FIG. 12 shows a non-linear understeer substitution. The substitute curve is less than the actual yaw rate curve, so the ESC sees a lesser value except at very towards the ends of the curves and at the maxima of the curves.

A further embodiment of the invention encompasses the fitment and use of adjustable anti-roll bars. Front and/or rear anti-roll bars with adjustable rates allow for changes to the relative front to rear roll stiffness delivering changes to the understeer or oversteer bias. For example, an hydraulic swaybar link can allow for precise control of the swaybars movement relative to the body. This involves digital control via a processor linked to a yaw and lateral G sensor allowing for differential roll rates front to rear to change the fundamental handling bias. Other methods include electric stepper motors to activate and control the physical “link” or connection between the swaybar, wheels and body. For example, the driver can select “more understeer” and the system can achieve this by either increasing the rate of the front swaybar, decreasing the rate of the rear or a combination of both.

Pneumatic or hydraulic virtual springs can also be used to deliver a similar outcome. It is possible to use air (pneumatic) or hyrdraulic (actuated rams) springs with digital rate control to change the roll stiffness and effective spring rate at individual or pairs of wheels. Current systems exist that can raise or lower the height of the vehicle or change the effective spring rate. As a component of spring rate will always exist in roll, the handling bias can be changed by altering the differential spring rate front to rear. As in the previous example, digital or electrical control of the springs allows for cockpit selectable or adjustable handling outcomes. For example, softening of the front spring rate tends to magnify oversteer and so stiffens the rate of the rear.

Dampers or shock absorbers can also be controlled to deliver a similar outcome. A damper is designed to “dampen” the wheels oscillations to minimise the number of vertical cycles at each wheel. Varying the rate of the damper at any given point has the effect of increasing or decreasing the spring rate momentarily. This is not as durable a change as when using spring rate or roll rate. Changes to fluid viscosity by magnetising suspended metallic particles can be used to alter the damper rate. In this way, the resistance to wheel oscillations can be changed at various stages within the compression or extension cycle to develop momentary and/or transitional increases to spring rate. An increase to the “bump” or compression rate can simulate a transient increase to spring rate. Done to the front, this has the effect of increasing understeer. Other methods use active changes in valving by way of solenoid or stepper motor. Digital or electrical control of these functions can deliver the same function.

In an alternative embodiment, the modifier may be used to modify the control signal outputs from ESC system in addition to, or instead of, operating on the input signals.

In the specification, the word “comprising” is understood in its “open” sense, that is, in the sense of “including”, and thus not limited to its “closed” sense, that is the sense of “consisting only of”. A corresponding meaning is to be attributed to the corresponding words “comprise, comprised and comprises where they appear.

While particular embodiments of this invention have been described, it will be evident to those skilled in the art that the present invention may be embodied in other specific forms without departing for the essential characteristics thereof. The present embodiments and examples are therefore to be considered in all respects as illustrative and not restrictive, the scope of the invention being indicated by the appended claims rather than the foregoing description, and all changes which come within the meaning and range of equivalency of the claims are therefore intended to be embraced therein. It will further be understood that any reference herein to known prior art is commonly known by those skilled in the art to which the invention relates.

The applicant does not concede that the background art described herein forms part of the common general knowledge.

1. A system for modifying the handling bias of a vehicle having one or more dynamic parameter sensors which produce sensor signals representative of parameters indicative of the current handling performance of a vehicle, and a vehicle handling performance controller responsive to the or each sensor signal to produce parameter control signals which are applied to parameter control devices to adjust the parameter towards a desired value in relation to the vehicles current handling status, the handling bias modifying system including a signal modifier which receives and modifies one or more of the sensor signals and/or one or more of the parameter control signals.

2. A system as claimed in claim 1, including an in-cockpit modifier controller having one or more control interfaces to permit a driver to adjust the modification of the sensor signals.

3. A system as claimed in claim 2, wherein the modifier controller includes a first interface which is adapted to enable the driver to select the nature of the modification of one or more of the signals.

4. A system as claimed in claim 3, wherein the modifier controller includes a second interface which is adapted to enable the driver to select the magnitude profile of the modification of one or more of the signals.

5. A method of modifying the handling bias of a vehicle having one or more dynamic parameter sensors which produce sensor signals representative of parameters indicative of the current handling performance of a vehicle, and a vehicle handling performance controller responsive to the or each sensor signal to produce parameter control signals which are applied to parameter control devices to adjust the parameter towards a desired value in relation to the vehicles current handling status, method including receiving and modifying one or more of the sensor signals and/or one or more of the parameter control signals.

6. A method as claimed in claim 5, including an in-cockpit modifier controller having one or more control interfaces to permit a driver to adjust the modification of the sensor signals.

7. A method as claimed in claim 6, including providing a first interface which is adapted to enable the driver to select the nature of the modification of one or more of the signals.

8. A method as claimed in claim 7, including providing a second interface which is adapted to enable the driver to select the magnitude profile of the modification of one or more of the signals.

9. A method of retrofitting a handling bias modifier to a vehicle equipped with one or more dynamic parameter sensors which produce sensor signals representative of parameters indicative of the current handling performance of a vehicle, and a vehicle handling performance controller responsive to the or each sensor signal to produce parameter control signals which are applied to parameter control devices to adjust the parameter towards a desired value in relation to the vehicles current handling status, the method including inserting a handling bias modifier between at least one of the sensors and the ESC, and modifying one or more of the sensor signals before applying the modified sensor signal to the vehicle handling performance controller.

10. A method as claimed in claim 9, including providing one or more driver-actuated interface controls to enable the driver to control the nature and/or degree of modification of the sensor signal.

11. An in-cabin vehicle handling bias control arrangement including a bias modifier having at least one interface to permit a driver to select modifications to the input and/or the output signals from a vehicle stability control system.
